(19) United States
(12) Patent Application Publication
(10) Pub. No.: US 2008/0314412 A1
(43) Pub. Date: Dec. 25, 2008

(54) Self-Cleaning Injection Port for Analytical Applications

(76) Inventors: Paul M. Grippo, Bedford, NH (US); Daniel L. Bantz, Brookline, NH (US); Frank Sylva, Tewksbury, MA (US); Thomas R. Londo, Ashland, MA (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/096,259

(22) PCT Filed: Dec. 4, 2006
(86) PCT No.: PCT/US06/46403

§ 371 Date: Sep. 9, 2008

Related U.S. Application Data
(60) Provisional application No. 60/742,386, filed on Dec. 5, 2005.
(60) Provisional application No. 60/748,853, filed on Dec. 7, 2005.
(60) Provisional application No. 60/803,295, filed on May 26, 2006.

(51) Int. Cl. B08B 9/027; G01N 30/16

(52) U.S. Cl. 134/22.11; 422/103

(57) ABSTRACT

A self-cleaning injection port assembly that uses a movable wash chamber closure device (26) for opening and closing an injection needle entry passage (34) of an injection port wash chamber. For sample injection, the wash chamber closure device (26) can be moved clear of the path along which the injection needle passes through the wash chamber into the injection port, thereby enabling insertion of the injection needle into the injection port. For washing, the wash chamber closure device (26) is moved to a position closing the entry passage (34) of the injection port wash, after which cleaning fluid may be circulated through the injection port for cleaning.

### RELATED APPLICATIONS

This application claims the benefit of U.S. Provisional Application Nos. 60/742,386 filed Dec. 5, 2005, 60/748,853 filed Dec. 7, 2005, and 60/803,295 filed May 26, 2006, all of which are hereby incorporated by reference in their entireties.

### FIELD OF THE INVENTION

The invention herein described relates generally to liquid sample (LC) or liquid chromatography/mass spectrometry (LC/MS) analytical systems.

### BACKGROUND

Analytical sampling systems are known, particularly in the biotechnology industry. A common feature of such systems is the use of a robotic or other motion control device to either move a fluid aspirating/dispensing syringe about a deck of vessels or other deck components, such as wash stations, reagent troughs and injection valves for analytical sampling devices.

A significant factor affecting analytical sampling device performance in such systems is the amount of remnant carry-over from previous samples to subsequent injections. Sample carry-over confounds the results of subsequent runs adding to overall analytical uncertainty. Carry-over arises from many aspects of liquid chromatography (LC) or liquid chromatography/mass spectrometry (LC/MS) equipment and operations. These include, but are not limited to incomplete cleaning/flushing to waste of surfaces routinely exposed to samples and other contaminants; unswept areas in the sample flow path into which sample molecules diffuse and build up over several runs until they concentrate enough to diffuse back into the bulk flow and pollute subsequent runs; uncleaned areas in the sampling path that only occasionally, through statistical incidence, come in contact with sampling elements; incomplete LC column elution resulting in buildup of highly retained compounds until they eventually migrate to the end of the column and exhibit themselves as spurious “ghost” peaks in the elution profile or mass spectrum or continuously bleed off of the column disrupting the signal baseline making peak area estimation difficult and uncertain; overspraying at the MS source causing buildup and contamination of inlet orifices, skimmers, and ion optics; and occasional samples containing contaminants for which the analysis was not designed to efficiently clear from the system. Some of these causes are insidious and only exhibit themselves sporadically over the course of several runs while others are more obvious and demonstrate themselves routinely from run to run.

One known mechanism used to effect injection port washing uses the injection syringe itself. In this case, after injecting the sample, the syringe barrel is washed internally and its probe is washed both internally and externally at a separate syringe wash area located within the sampling device's workspace. The clean syringe is then charged with cleaning solution, moved back to the injection port, inserted into the port, and the cleaning solution forced through the injection mechanism. At this point, the syringe is considered to have become contaminated since it might have contacted residual sample clinging to the injection port as it was being inserted. Consequently, the syringe must once again be washed both internally and externally to prepare it for aspirating the next sample.

Although the foregoing technique is nominally adequate for flushing the contaminated elements distal to the syringe to injection port seal, it has several drawbacks. The process is slow. The many syringe actuations required to clean the syringe, clean the injection port, and then clean the syringe again, greatly reduces the syringe seal lifetime. The injection port may remain contaminated proximal to the syringe to injection port seal despite the cleaning process. As the syringe containing the next sample is inserted into the injection port it might slide along the contaminated wall as it finds its seat, dragging the contaminant into the system with it. The additional syringe insertions into the injection port also reduces the injection port sealing surface lifetime resulting in only about half the number of samples being able to be injected before the seal needs to be replaced.

Another washing technique employs a dedicated injection port wash mechanism which does not require assistance by the device's injection syringe. One such mechanism is disclosed in U.S. Pat. No. 6,526,812. This mechanism includes a fixed wash chamber bounded by the walls of the injection port on the sides, with an inlet port for introducing washing solution. The top of the wash chamber is sealed by a penetrable, self-sealing septum. Consequently, during sample injection, the injection needle of the syringe must be inserted through the septum.

While this dedicated wash mechanism eliminates some of the disadvantages associated with the syringe-based washing technique, it introduces its own disadvantages. One problem is that of the septum being cored by the syringe, this resulting in clogged syringes and a leaky septum. Another disadvantage is the deposition of contaminating drops on the top of the septum which might be dragged or pushed through to the injection area on subsequent samples, resulting in carry-over.

### SUMMARY OF THE INVENTION

This present invention eliminates one or more of the drawbacks associated with prior injection port wash mechanisms and techniques. In particular, the invention provides a self-cleaning injection port assembly that eliminates the need for the above-described septum and the disadvantages associated therewith. This is effected by the use of a movable wash chamber closure device for opening and closing an injection needle entry passage of an injection port wash chamber. For sample injection, the wash chamber closure device can be moved clear of the path along which the injection needle passes through the wash chamber into the injection port, thereby enabling insertion of the injection needle into the injection port. For washing, the wash chamber closure device is moved to a position closing the entry passage of the injection port wash, after which cleaning fluid may be circulated through the injection port for cleaning.

Accordingly, the present invention provides a self-cleaning injection port assembly for use with a liquid chromatography injection valve, comprising an injection port body and a wash chamber closure device. The injection port body defines an interior chamber having an upper chamber portion and a lower chamber portion, an entry opening through which an injection needle can be inserted into the interior chamber, a wash port connected to the upper chamber between the entry opening and the lower chamber portion, and an outlet communicating with the lower chamber portion. The lower chamber portion has associated therewith a needle sealing surface surrounding a portion of the lower chamber portion for effecting a seal with the injection needle when inserted into the interior chamber, and the upper chamber portion has, at least in the region thereof located between the wash port and the entry opening, a cross-sectional size greater than a cross-sectional area bounded by the needle sealing surface whereby in such region the injection needle, when inserted therein, will be spaced from the interior wall of the upper chamber to preclude the transfer of any foreign material clinging to the exterior surface of the needle from touching the interior wall of the upper chamber. The wash chamber closure device is movable between a first position allowing an injection needle to be inserted through the entry opening into the interior chamber of the injection port body and into sealing engagement with the needle sealing surface, and a second position closing the entry open end of the chamber after the injection needle has been withdrawn from the interior chamber, whereby a wash fluid may be passed through the wash port, upper chamber, lower chamber and outlet for cleaning.

In a preferred embodiment, the wash chamber closure device includes a seal for sealing to the interior wall of the upper chamber, and a swing arm is used to move the washing device between the first and second positions. The swing arm may move the washing device laterally relative to an axis and along the axis.

More generally, the present invention provides a self-cleaning injection port assembly for use with a liquid chromatography injection valve, comprising an injection port body including an interior wash chamber having an entry opening for insertion of an injection needle therethrough, and a wash chamber closure device movable between a first position allowing the injection needle to be inserted through the entry opening into the interior chamber of the injection port body and a second position closing the entry opening of the chamber after the injection needle has been withdrawn from the interior chamber for cleaning. Cleaning fluid may be supplied to and/or withdrawn from the wash chamber via a wash port provided in the wash chamber closure device and/or in the port body.

According to another aspect of the invention, there is provided a method of cleaning an injection port assembly, wherein the injection port assembly includes an injection port body having an interior wash chamber with an entry opening for insertion of an injection needle therethrough. The method comprises the steps of moving a washing device from a first position allowing the injection needle to be inserted through the entry opening into the interior chamber of the injection port body to a second position closing the entry opening of the chamber after the injection needle has been withdrawn from the interior chamber, and causing cleaning fluid to flow through the interior chamber when the washing device is in the second position closing the entry opening. The cleaning fluid may be introduced into the interior chamber through a flow passage in the washing device or a flow passage in the injection port body.

Further features of the invention will become apparent from the following detailed description when considered in conjunction with the drawings.

### BRIEF DESCRIPTION OF THE DRAWINGS

In the annexed drawings,

FIG. 1 is a front perspective view of an exemplary embodiment of a self-cleaning injection port assembly according to the invention, with a wash chamber closure device of the assembly offset to one side of the path along which an injection needle would move for insertion into the injection port of the assembly;

FIG. 2 is a rear perspective view of the self-cleaning injection port assembly;

FIG. 3 is a front elevational view of the self-cleaning injection port assembly;

FIG. 4 is a cross-sectional view of the self-cleaning injection port assembly, taken along the line A-A of FIG. 3;

FIG. 5 is a cross-sectional view of the self-cleaning injection port assembly, taken along the line B-B of FIG. 3;

FIG. 6 is an enlarged portion of FIG. 4.

FIG. 7 is a cross-sectional view similar to FIG. 5, but showing an exemplary syringe inserted into the injection port assembly;

FIG. 8 is an enlarged portion of FIG. 7, showing in greater detail the injection needle of the syringe in relation to a wash chamber of the injection port assembly;

FIG. 9 is a cross-sectional view similar to FIGS. 5 and 7, but showing the wash chamber closure device positioned to close the injection port for washing; and

FIG. 10 is an enlarged portion of FIG. 9, showing in greater detail the wash chamber closure device in relation to the wash chamber of the injection port assembly.

FIG. 11 is a fragmentary cross-sectional view similar to FIG. 9, showing another form of wash chamber closure device in accordance with the invention.

FIG. 12 is a fragmentary cross-sectional view similar to FIG. 11, but showing still another form of wash chamber closure device in accordance with the invention.

### DETAILED DESCRIPTION

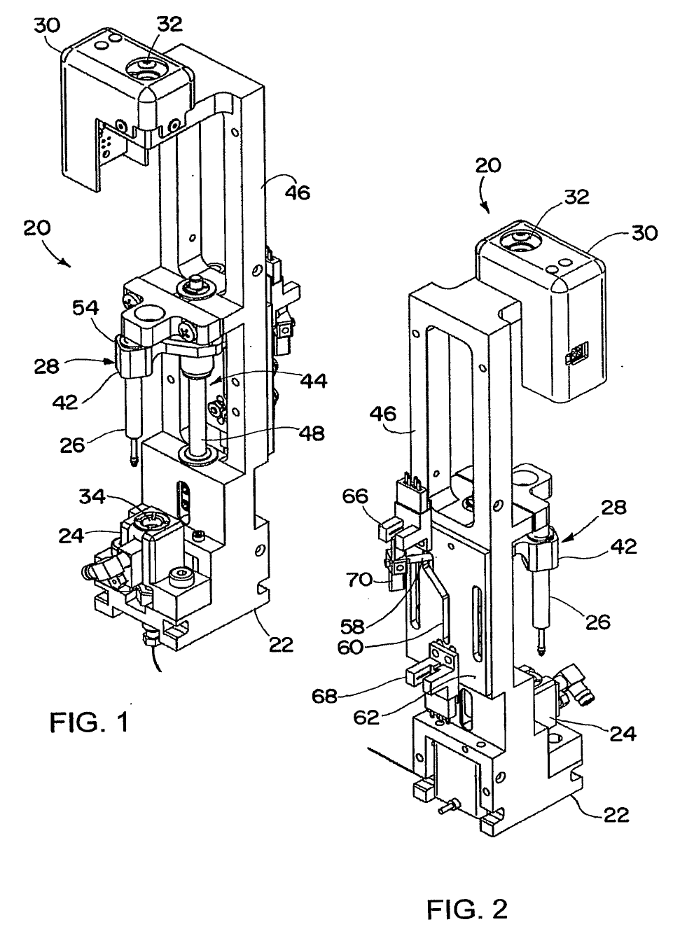

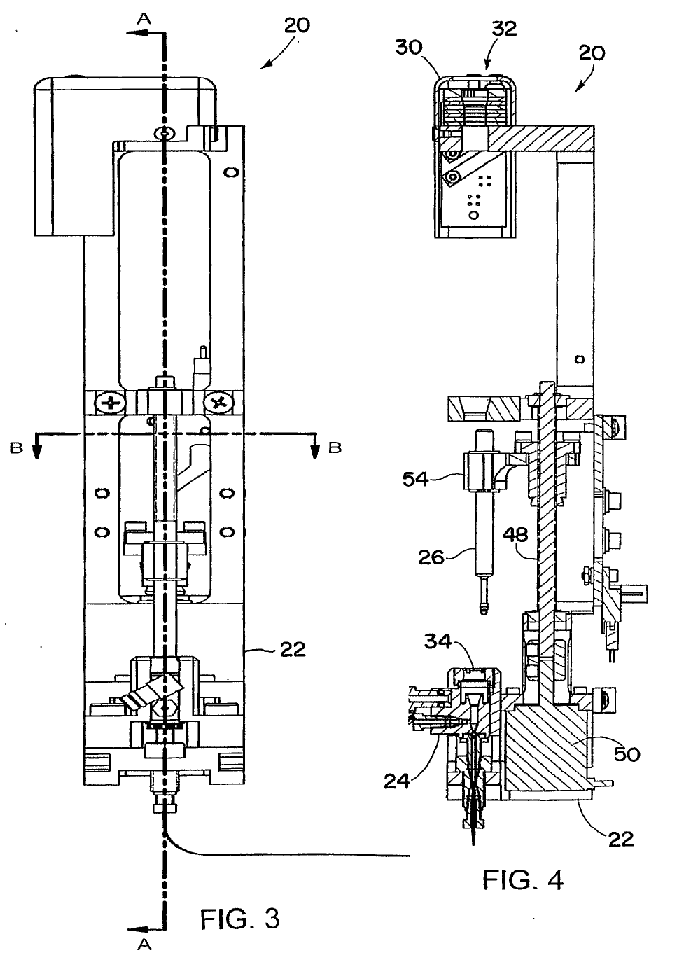

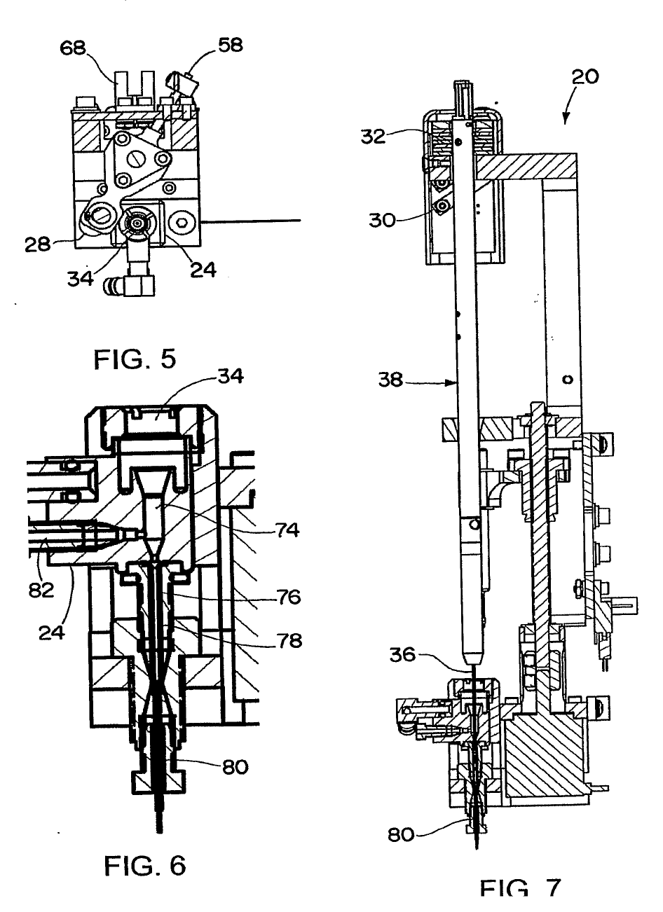

Referring now in detail to the drawings and initially to FIGS. 1-5, an exemplary embodiment of a self-cleaning injection port assembly according to the invention is indicated generally at 20. The illustrated injection port assembly 20 includes a base 22 (or other frame/support structure) in which are formed or to which are attached various parts of the assembly, such as a injection port body 24, a wash chamber closure device 26 via a carriage assembly 28, and a syringe holder 30 including a syringe interface device 32. As will be appreciated by those skilled in the art, the injection port assembly 20 may be oriented otherwise than as shown. However, for convenience in description and not by way of limitation, the relationship between and movement of parts or the injection port assembly will be described with reference to the illustrated orientation thereof.

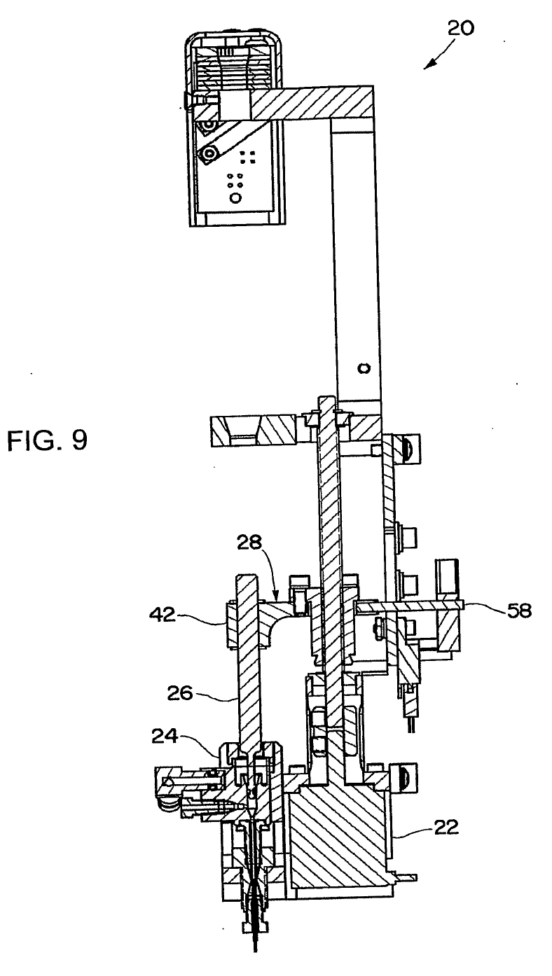

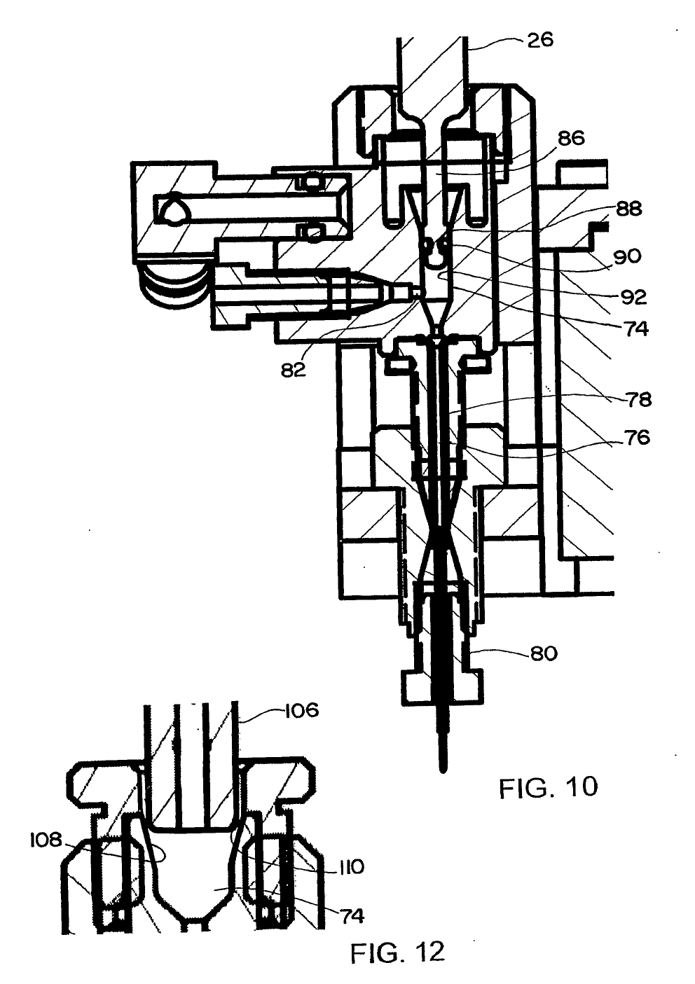

The injection port body 24 has at a top end thereof an entry opening 34 through which an injection needle 36 of a syringe 38 can be inserted downwardly into the injection port body 24 (as shown in FIG. 6). The wash chamber closure device 26 is movable between a first position (FIGS. 1-3) allowing the injection needle 36 to be inserted through the entry opening 34 into the injection port body 24 and a second position (FIGS. 9 and 10) closing the entry opening 34 after the injection needle 36 has been withdrawn from the injection port body for cleaning. Any suitable means may be used to effect such movement, such as the illustrated carriage assembly 28. The carriage assembly 28 includes a carriage 42 that is movable along a vertical axis by a lead screw and nut assembly 44 mounted to an upright portion 46 of the base 22. The lead screw 48 is rotatable in opposite directions by a motor 50 for raising and lowering the carriage. Operation of the motor may be controlled by any suitable means such as a motor controller, and particularly one that is integrated into or forms part of an injection port controller that in turn may be integrated into or form part of an overall analytical system controller.

The carriage 42 has a forward swing arm portion 54 to which the wash chamber closure device 26 is mounted, and a rear arm that has a guide pin 58 engaged in a cam slot 60 in a cam plate 62 mounted to the upright portion 46 of the base 22. As the carriage is lowered along the lead screw of the lead screw and nut assembly, the cam slot first guides the carriage downwardly out of a park position, then rotates the carriage about the axis of the lead screw to vertically align the closure device 26 with the entry opening 34, and then holds the carriage against further rotation to guide the closure device 26 into the entry opening 34. The closure device 26 will be guided in an opposite manner during retraction of the closure device 26 from the entry opening 34.

Sensors 66 and 68 are provided to detect the park and closed positions of the closure device 26 during raising and lowering of the closure device 26. To this end, the distal end of the rear arm may be provided with a vertical member 70, the ends of which respectively will move into the slots of sensors mounted to the cam plate at opposite ends of the cam slot 60. The sensors may be of any suitable type, such as optical beam sensors, hall effect sensor, contact sensors, etc. The sensors provide feedback to the controller so that the controller knows when the closure device 26 has reached its park or closed positions so that it can stop further operation of the motor.

As shown in FIG. 6, the injection port body 24, which may be fabricated from one or more components, defines an interior chamber having an upper (wash) chamber portion 74 and a lower (injection) chamber portion 76. The lower chamber portion has associated therewith a needle sealing surface that surrounds at least part of the lower chamber portion for effecting a seal with the injection needle 36 when inserted into the interior chamber. In the illustrated embodiment the sealing surface is formed by a sleeve seal 78 as is typical in the art. The sleeve seal 78 has a center passage that closely receives the injection needle 36 of a syringe 38 to effect a seal therewith.

The opening at the lower end of the sleeve seal 78 communicates with an outlet 80 of the injection port that may be connected in a conventional manner to an injection valve and associated tubing and/or passages. The injection body also includes a wash port 82 opening to a side of the upper chamber 74 between the lower chamber portion and the entry opening 34. The wash port may be connected by suitable means to a source of cleaning fluid or a reservoir or drain for cleaning fluid, depending on the desired flow path of cleaning fluid through the injection port assembly.

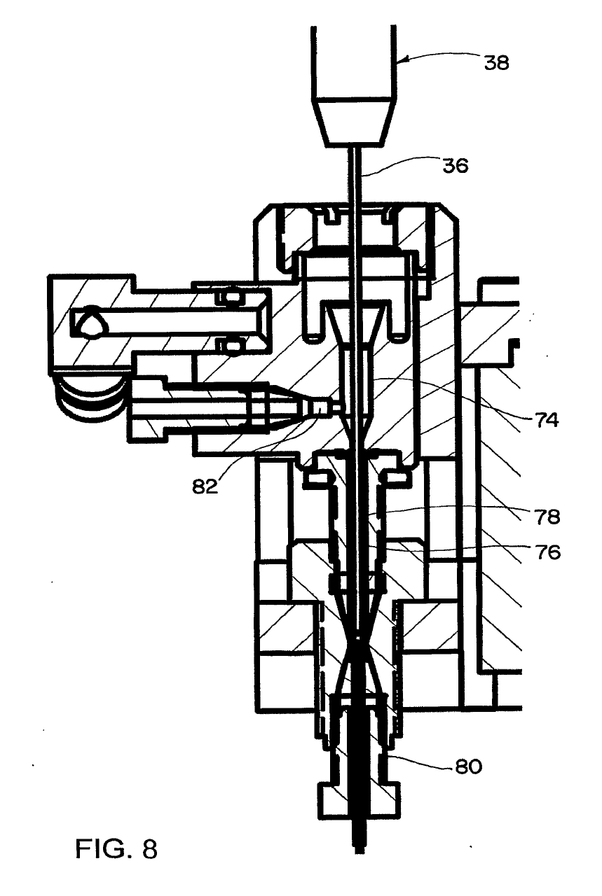

The upper or wash chamber 74 opens to the top of the injection port body 24 via the entry opening 34 through which the injection needle 36 can be inserted into the interior chamber as shown in FIGS. 7 and 8. In the illustrated embodiment, the syringe 38 is axially inserted by a robotic device or otherwise through the syringe holder 30 until the injection needle 36 is inserted and sealed in the sleeve seal 78. The syringe 38 may be provided with a suitable stop for limiting such insertion movement to avoid over-insertion. As above-mentioned, the holder includes a syringe interface device 32 for establishing communication between the injection wash device and the syringe 38, whereby commands can be received from the syringe 38 or issued to the syringe 38 from a injection port controller and/or overall system controller.

For further details of a suitable syringe and its manner of interfacing with control components and functional stations of an analytical system or systems, reference may be had to International Patent Application No. PCT/US06/02845 which is hereby incorporated herein by reference. For instance, an injection procedure may be effected under the control of the syringe 38 that may include a suitably programmed logic control device. The interface device may also provide power to the syringe 38 when held in the injection port assembly. It is noted, however, that other types of syringes may be used with the self-washing injection port device, including syringes that are inserted manually as well as those used by conventional autosampling systems where the syringe is tethered to a gantry system. In the former case, the user could inject by hand and click a “Wash Port” button on a software screen to begin a port washing sequence and in the latter case, a port washing sequence could be triggered by the main control software once the injection has competed and the gantry and syringe have moved out of the way.

As best seen in FIG. 8, the upper chamber portion (wash chamber) has, at least in the region thereof located between the wash port 82 and the entry opening 34, a cross-sectional size greater than a cross-sectional area bounded by the needle sealing surface (the inner cylindrical surface of the seal sleeve 78). In this region that extends to the entry opening 34, the injection needle 36 will be spaced from the interior wall of the upper chamber to preclude the transfer of any foreign material clinging to the exterior surface of the needle 36 from touching the interior wall of the upper chamber. The distance between the outside surface of the syringe needle 36 and the inside surface of the noted region of the upper chamber may be at least about 0.65 mm. Otherwise a droplet clinging to the needle 36 might come in contact with the upper chamber wall. Thus, in relation to the needle sealing surface in the lower chamber portion, the wall surrounding the enlarged region of the upper chamber portion is laterally outwardly offset from the needle sealing surface of the lower chamber portion by at least about 0.65 mm. Since the needle's sealing surface and the enlarged region of the upper chamber preferably are cylindrical, the enlarged region will have a diameter that is greater than the diameter of the needle sealing surface by at least about 1.3 mm. Of course the spacing can be greater, such as about 0.7 mm, or about 1.0 mm, or about 1.5 mm, or greater.

After a sample injection the syringe 38 can be removed and the wash chamber closure device 26 moved from its stowage position to its position closing the entry opening 34 of the injection port body 24 as shown in FIGS. 9 and 10. In the illustrated embodiment, the wash chamber closure device 26 is an elongated member that has a reduced diameter lower stem portion 86. For sealing purposes, the lower stem portion may have formed therein an annular groove 88 for receiving an annular seal 90 such as an ◯-ring. The ◯-ring is sized to seal against the inner wall surface 92 of the upper chamber at the enlarged region thereof that extends to the entry opening 34. In a preferred embodiment, the ◯-ring or other seal should be able to withstand upwards of 1000 psi to allow for pumping of cleaning solvents at high pressure and high rates for fast cleaning. If desired and as shown, the entry opening 34 may taper outwardly to provide a wide receiving mouth for the closure device 26.

The seal 90 between the closure device 26 and the wash chamber 74 may be made at surfaces proximal to any surface that could possibly come in contact with the syringe 38 or any contaminating material carried by the syringe 38. Thus, all surfaces within the injection port assembly that can possibly become contaminated during the injection process can be completely washed during the washing process. Wash solution may be directed through the wash port 82 and into the interior chamber of the injection port body for passage out through the outlet 80 to the injection valve, resulting in complete cleaning and minimal carryover.

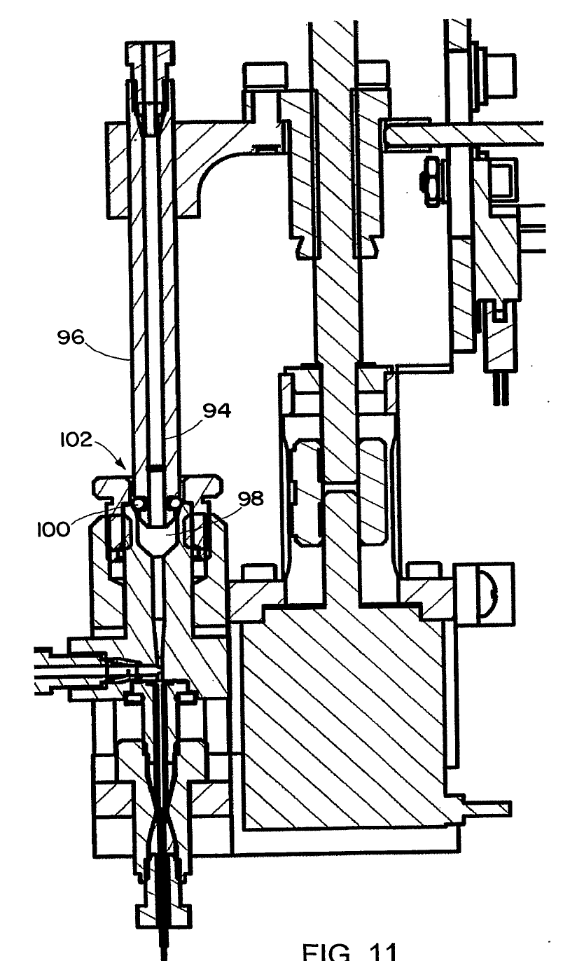

Those skilled in the art will appreciate that various modifications can be made to the illustrated exemplary injection port wash assembly while still using one or more principles of the present invention. For example, the wash port may be replaced by or supplemented by a wash port 94 provided in the closure device 96 as seen in FIG. 11, which port opens to the end of the closure device 96 for introducing (or withdrawing) cleaning solution into the wash chamber 98 when the closure device 96 is positioned to close the entry opening 34. As shown, the annular seal 100 on the closure device may seal against the tapered mouth of the entry opening 102.

Alternatively, a hard seal may be provided between a modified closure device 106 and the tapered mouth 108 of the wash chamber 74 as shown in FIG. 12. The closure device may have a small radius 110 on its distal end and the mouth 108 to the upper chamber has a small bevel which is dissimilar to the radius on the closure device so that the closure device can wedge into the tapered mouth of the upper chamber if the closure device is inserted with some force. Thus, for example, moving the closure device along its long axis into the mouth of the upper chamber and holding it in place with approximately 8 pounds of force can provide approximately 1000 psi of back-pressure to prevent leaking.

As will be appreciated, any of the illustrated sealing arrangements between the closure device and the wash chamber can be used interchangeably, as desired.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A self-cleaning injection port assembly for use with a liquid chromatography injection valve, comprising:
an injection port body defining an interior chamber having an upper chamber portion and a lower chamber portion, an entry opening through which an injection needle can be inserted into the interior chamber, a wash port connected to the upper chamber between the entry opening and the lower chamber portion, and an outlet communicating with the lower chamber portion, the lower chamber portion having associated therewith a needle sealing surface surrounding a portion of the lower chamber portion for effecting a seal with the injection needle when inserted into the interior chamber, and the upper chamber portion having, at least in the region thereof located between the wash port and the entry opening, a cross-sectional size greater than a cross-sectional area bounded by the needle sealing surface whereby in such region the injection needle, when inserted therein, will be spaced from the interior wall of the upper chamber to preclude the transfer of any foreign material clinging to the exterior surface of the needle from touching the interior wall of the upper chamber; and
a washing device movable between a first position allowing an injection needle to be inserted through the entry opening into the interior chamber of the injection port body and into sealing engagement with the needle sealing surface, and a second position closing the entry opening of the chamber after the injection needle has been withdrawn from the interior chamber, whereby a wash fluid may be passed through the wash port, upper chamber, lower chamber and outlet for cleaning.

2. self-cleaning injection port assembly as set forth in claim 1, wherein the washing device includes an annular seal for sealing to the interior wall of the upper chamber.

3. A self-cleaning injection port assembly as set forth in claim 2, wherein the annular seal includes an ◯-ring seal.

4. A self-cleaning injection port assembly as set forth in claim 2, wherein the annular seal includes a tapered surface on one of the washing device and interior wall of the upper chamber.

5. A self-cleaning injection port assembly as set forth in claim 1, wherein a swing arm is used to move the washing device between the first and second positions, the swing arm supporting the washing device for pivotal movement about an axis and for moving the washing device along the axis.

6. A self-cleaning injection port assembly as set forth in claim 1, wherein the interior chamber has a center axis, the sealing surface is radially spaced from the center axis by a first distance, and the interior wall of the upper chamber in said region thereof located between the wash port and entry opening is spaced from the center axis by a second distance that is greater than the first distance by at least about 0.65 mm.

7. A self-cleaning injection port assembly for use with a liquid chromatography injection valve, comprising an injection port body including an interior wash chamber having an entry opening for insertion of an injection needle therethrough, and a washing device movable between a first position allowing the injection needle to be inserted through the entry opening into the interior chamber of the injection port body and a second position closing the entry opening of the chamber after the injection needle has been withdrawn from the interior chamber for cleaning.

8. A self-cleaning injection port assembly as set forth in claim 7, wherein the washing device includes a fluid passage for introducing cleaning fluid into the interior chamber when the washing device is in the second position.

9. A self-cleaning injection port assembly as set forth in claim 7, wherein the interior chamber has a cleaning fluid inlet opening to a side of the interior chamber through which cleaning fluid can be introduced into the interior chamber.

10. A self-cleaning injection port assembly as set forth in claim 1, comprising a holder for the syringe and an injection port controller, the holder including a syringe interface device for establishing communication between the injection port controller and the syringe, whereby commands can be received from the syringe or issued to the syringe by or from the injection port controller.

11. A method of cleaning an injection port assembly, wherein the injection port assembly includes an injection port body having an interior wash chamber with an entry opening for insertion of an injection needle therethrough, the method comprising the steps of moving a washing device from a first position allowing the injection needle to be inserted through the entry opening into the interior chamber of the injection port body to a second position closing the entry opening of the chamber after the injection needle has been withdrawn from the interior chamber, and causing cleaning fluid to flow through the interior chamber when the washing device is in the second position closing the entry opening.

12. A method as set forth in claim 11, wherein cleaning fluid is introduced into the interior chamber through a flow passage in the washing device or a flow passage in the injection port body.
